(19) United States
(12) Patent Application Publication
(10) Pub. No.: US 2005/0208939 A1
(43) Pub. Date: Sep. 22, 2005

(54) System and method for providing adaptive service through wireless delivery

(75) Inventor: Takeshi Yoshida, Osaka (JP)

Correspondence Address: MCDERMOTT WILL & EMERY LLP, 600 13TH STREET, N.W., WASHINGTON, DC, 20005-3096, US

(73) Assignee: MATSUSHITA ELECTRIC INDUSTRIAL CO., LTD.

(21) Appl. No.: 11/073,733

(22) Filed: Mar. 8, 2005

(30) Foreign Application Priority Data
Mar. 8, 2004 (JP) 2004-064256

(51) Int. Cl. H04Q 7/20

(52) U.S. Cl. 455/432.3

(57) ABSTRACT

When a STA is connected newly and requests a band acquisition, an AP queries a server about contract information of a user using the STA. The requested band is compared with the contract information to confirm whether the user requests the band in accordance with the contract information. When the comparison results in “NO” (the requested band is beyond the contract information), the requested band is changed to a band in accordance with the contract information. When the comparison results in “YES” (the requested band is within the contract information), the band as requested is allocated to the newly connected STA.

### CROSS REFERENCE TO RELATED APPLICATIONS

This Non-provisional application claims priority under 35 U.S.C. § 119(a) on Patent Application No. 2004-064256 filed in Japan on Mar. 8, 2004, the entire contents of which are hereby incorporated by reference.

### BACKGROUND ART

The present invention relates to a system for providing adaptive service through wireless delivery and an adaptive service providing method using it, and particularly relates to a band control technology used for providing hot spot service using a wireless function and for video delivery by means of AV equipment having a wireless function.

In conventional wireless connection services, network resources necessary for supporting an admitted session is allocated in such a manner that a resource manager offers admission control to prohibit admission of a session that a system cannot support. Also, a polling manager adjusts a band allocated to a terminal by changing a polling frequency (see Published Japanese Translation of PCT International Publication for Patent Application No. 2001-516173A).

Further, a user who is to purchase a digital content through delivery service receives the service in exchange for sending a transfer condition that high-quality transfer is carried out to a digital content provider (see Japanese Patent Application Laid Open Publication No. 2001-175757A).

For reserving in advance a band that a user is to use, a band is allocated in such a manner that the user specifies a band to be used through a wireless terminal that the user uses and a resource manager of a terminal connected to a wire network that provides services compares the band that the user is requesting with an available band.

FIG. 1 shows connection service in the case where a user terminal receives video delivery service in public services such as a hot spot or a case of wireless connection by means of AV equipment and the like to which a wireless image transfer function is incorporated, and FIG. 2 shows a radio link state. Terminals (hereinafter referred to as STAs) 1 through to 10 that users use for receiving the wireless connection service are connected to a terminal (hereinafter referred to as AP) that provides the wireless connection service. The AP is wireless connected to the STAs 1 through to 10, and is wire connected to a server that manages users' user information.

FIG. 3 shows a sequence for connection between a STA and an AP. In ST1, in order to detect an AP to which a STA is to be connected, the STA requests wireless link information acquisition for acquiring a beacon frame that the AP sends out.

In ST2, wireless link information for specifying the AP to which the STA is to be connected is acquired by acquiring the beacon that the AP sends out.

The STA requests for the AP a wireless link connection for establishing wireless link to the AP in ST3. When the AP admits wireless link connection to the STA, the STA is notified so through a wireless link connection response in ST4. When the AP does not admit wireless link connection otherwise, the STA is notified so through the wireless link connection response in ST4 as well.

In ST5, a user using the STA inputs user information such as a user ID, a password, and the like. Upon receipt of the input, the AP performs user confirmation by querying a server in ST6, and the server sends user information to the AP to notify the contract information of user information in ST7. When it is judged based on the user information that the user using the STA is a proper customer who establishes a contract, a usability notification is sent to the STA to offer use admission to the STA in ST8.

In ST9, in order to acquire a band to be used, the STA that receives the usability notification sends a band acquisition request to the AP.

Upon receipt of the request in ST9 from the STA, the AP allocates, through a band acquisition response in ST10, a band to the STA from a band that the AP manages.

### SUMMARY OF THE INVENTION

However, in the wireless connection service of the above Published Japanese Translation of PCT international publication for patent application No. 2001-516173A, a band that the user can be used is managed according to the polling frequency. Therefore, data transfer is not guaranteed in all time in the case, for example, where a user transfers data which should not be interrupted such as contents data. Thus, data transfer with no interruption cannot be guaranteed.

Also, in the wireless connection service of Japanese Patent Application Laid Open Publication No. 2001-175757A, a usable band is secured only when a user purchases contents by using a wireless terminal but it is not guaranteed that the services can be received all time in the same band.

Moreover, in the aforementioned method of reserving in advance a band that a user is to use, even when the user requests a band beyond contents of a contract that the user establishes, the resource manager admits band allocation if a sufficient range of a band that the resource manager manages remains, with a result that a band cannot be allocated to a terminal connected later.

Specifically, in the case where the terminals (STAs) 1 trough to 10 that the users use for receiving the wireless connection service are connected to the terminal (AP) that provides the wireless connection service and the AP connects the terminals sequentially in an order from the STA 1 for allocating bands as the STAs are requesting, the band allocation as shown in FIG. 4 is performed. Herein, if the user of the STA 1 through to the STA 7 establish a standard contract while the users of the STA 8 through to the STA 10 establish a premium contract, as shown in FIG. 5, a STA which is under the premium contract and which is to be connected later is not admitted to connect to the AP with no priority though the premium contract is more expensive than the standard contract.

Further, under the circumstances shown in FIG. 2, the AP must follow the steps of ST8 (to send a usability notification) and ST9 (to receive a band acquisition request) in FIG. 3 for changing the band for a STA, which means constrained band change at the AP.

Furthermore, because the AP allocates as-requested bands to the STAs 1 through to 10, a user who establishes a low-class contract can acquire a band beyond the contract information. Band allocation based on user information necessitates the steps of ST6 (to confirm user) and ST7 (to send user information) in FIG. 3.

In addition, a user who establishes no contract cannot receive the wireless delivery service.

As described above, in the conventional wireless connection services, a band not in accordance with the contents of which a user establishes a contract may be allocated as a band to be used by users and band reallocation according to the circumstances cannot be performed.

The present invention has been made in view of the above problems and has its object of performing band allocation in accordance with user's contract information.

Specifically, the present invention provides a system for providing adaptive service through wireless delivery including: a sever that manages user information relating to users; and a server terminal which is connected to the server and has a wireless communication function, wherein when a user terminal having a wireless communication function is wireless connected to the server terminal, wireless delivery service is provided to a user using the user terminal, and a band is allocated to the user terminal based on the user information that the server terminal obtains by querying the server.

Further, the present invention provides a method for providing adaptive service through wireless delivery using the above system for providing adaptive service through wireless delivery, wherein it is possible that: a procedure for changing a band of a user terminal only is performed by the server and the server terminal; and a band is reallocated by the server terminal based on the user information according to an increase or a decrease in a number of wireless connected user terminals.

Furthermore, in the present invention, when a band to be allocated to a newly wireless connected user terminal cannot be ensured, a user terminal under a low-class contract based on the user information among already wireless connected user terminals may be disconnected to secure the band to be allocated thereto.

Alternatively, in the present invention, when a band to be allocated to a newly wireless connected user terminal cannot be ensured, a band of 0 Mbps may be allocated to a user terminal under a low-class contract based on the user information among already wireless connected user terminals to secure the band to be allocated thereto.

Further, in the present invention, when a user requests a band beyond contract information that the user establishes, a band may be allocated to user's user terminal based on the user information.

Furthermore, in the present invention, a band may be allocated to the user terminal based on information on a key provided beforehand to the user.

In addition, in the present invention, wireless delivery service on a best effort basis may be provided to a user having no key.

As described above, in the present invention, bands to be allocated are adapted according to users' contract information. In consequence, connection of the server that manages the user's user information to the server terminal (AP) enables the AP to acquire the user information from the server when connected to the user terminal (STA), thereby allocating a band appropriate to the contract information.

The band of the STA to which the AP is connected can be confirmed from the server, with a result that band change is enabled with the need for the steps for band change at the STA eliminated.

Further, even if an insufficient range for band change remains, a band can be secured by disconnecting a STA of a user who establishes a low-class contract subjected to low priority after confirming the user's contract information.

Also, even if an insufficient range for band change remains, a band can be secured by allocating a band of 0 Mbps for a user who establishes a low-class contract.

If the STA that a user uses requests a band beyond his/her contract information, the AP allocates a band in accordance with the contract information of the user information stored in the server, thereby preventing allocation of a band beyond the contract information.

Moreover, when a key is used for user identification and information on band allocation is provided to the key, band allocation can be performed with no need of the AP to query the server about user's contract information, resulting in improvement in responsiveness in band allocation.

In addition, even when a user having no key with no contract established requests connection, provision of the wireless delivery service on the best effort basis enables differentiation of a user who establishes a contract and provision of services to the user who establishes no contract.

### BRIEF DESCRIPTION OF THE DRAWINGS

FIG. 1 is a drawing showing a wireless connection service providing system.

FIG. 2 is a drawing showing a radio link state.

FIG. 3 is a drawing showing a sequence for providing wireless connection service.

FIG. 4 is a drawing showing band allocation with no contract information reflected.

FIG. 5 is a drawing indicating contract information of each user.

FIG. 6 is a drawing indicating customer control information.

FIG. 7 is a drawing showing a sequence for band allocation appropriate to the contract information.

FIG. 8 is a flowchart depicting a flow of internal processing of an AP for band allocation appropriate to the contract information.

FIG. 9 is a drawing showing band allocation reflecting the contract information.

FIG. 10 is a drawing showing a radio link state when a terminal is connected newly.

FIG. 11 is a drawing showing a sequence for disconnecting a terminal under a low-class contract when a terminal is connected newly.

FIG. 12 is a flowchart depicting a flow of internal processing of the AP for disconnecting a terminal under the low-class contract when a terminal is connected newly.

FIG. 13 is a drawing showing a radio link state when a terminal is connected newly.

FIG. 14 is a drawing showing a sequence for allocating a band of 0 Mbps to a terminal under the low-class contract when a terminal is connected newly.

FIG. 15 is a flowchart depicting a flow of internal processing of the AP for allocating a band of 0 Mbps to a terminal under the low-class contract when a terminal is connected newly.

FIG. 16 is a drawing showing a radio link state when a terminal using a key is connected newly.

FIG. 17 is a drawing showing a sequence for providing radio link service through key input.

FIG. 18 is a flowchart depicting a flow of internal processing of the AP for providing the radio link service through key input.

FIG. 19 is a drawing showing a sequence for providing radio link service through NULL key input.

FIG. 20 is a flowchart depicting a flow of internal processing of the AP for providing the radio link service through NULL key input.

### DETAILED DESCRIPTION OF THE INVENTION

Embodiments of the present invention will be described below in detail with reference to the drawings. The preferred embodiments describe mere examples essentially, and does not intend to limit the applicable fields and usage of the present invention.

### First Embodiment

A system for providing wireless delivery service in the present embodiment is essentially the same as that in the conventional example described above, and only differences will be descried while allotting the same reference numerals to the same elements as in the conventional example. The same is applied to the following second and third embodiments.

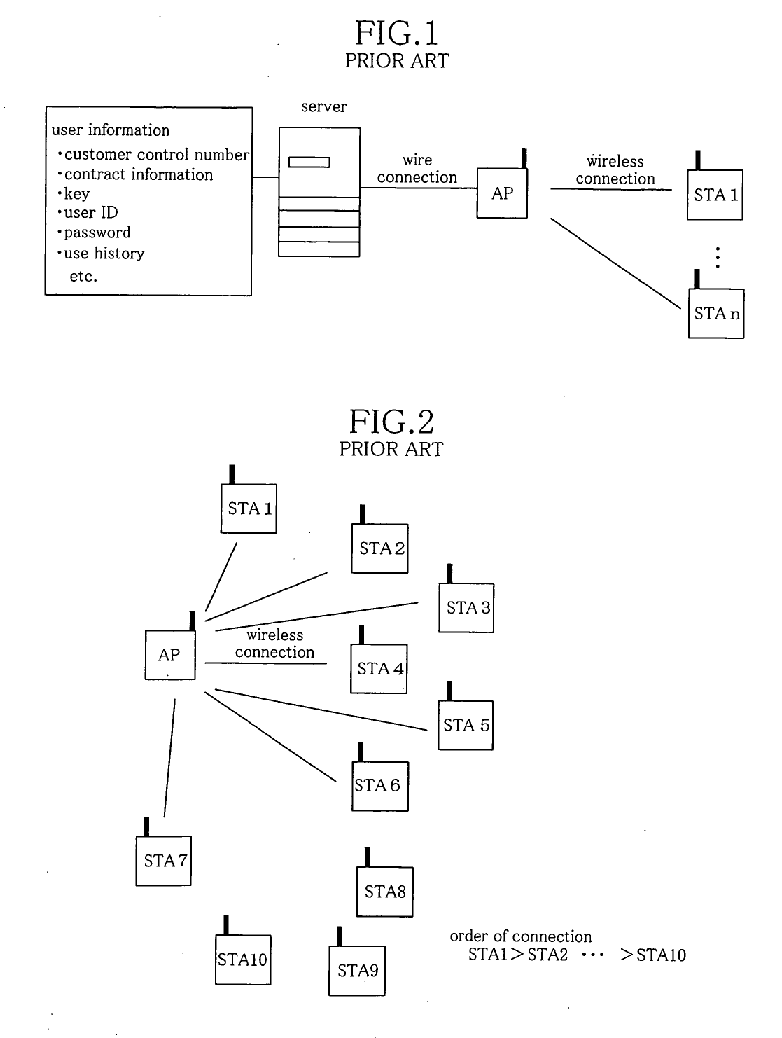

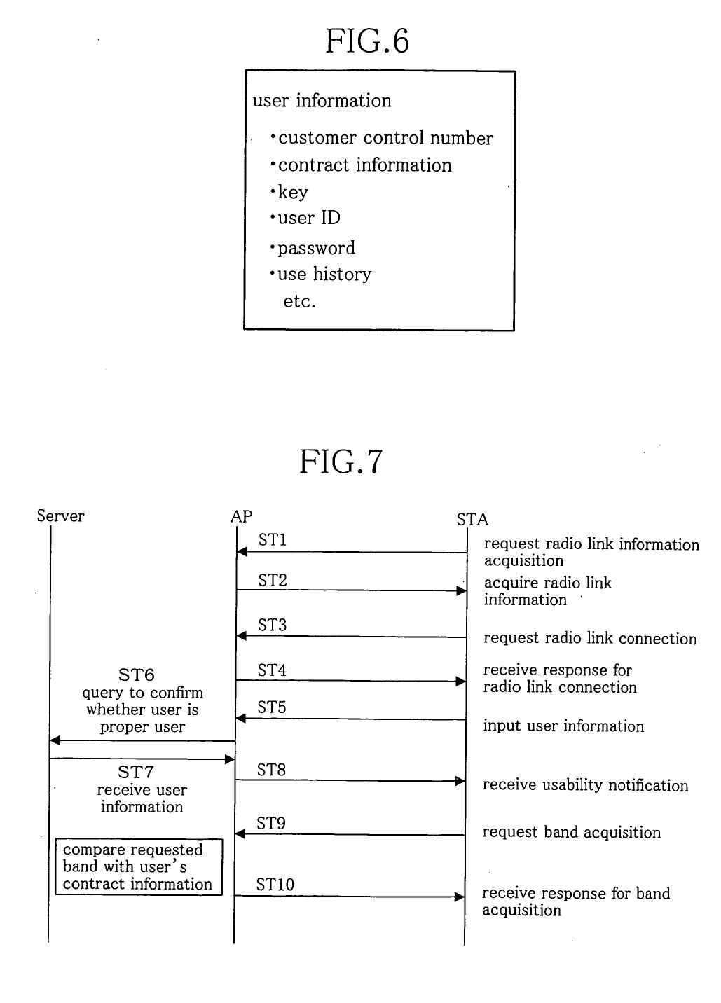

A server shown in FIG. 1 manages information as indicated in FIG. 6 as user information, and the contents thereof includes: each user's customer control number for management; each user's contract information in accordance with which each user establishes a contract for receiving the wireless connection service; key information necessary in wireless connection for receiving the wireless connection service; user IDs for identifying users; passwords for authenticating users as proper users; use histories that indicate the degree of users' past use of the wireless delivery service; and the like.

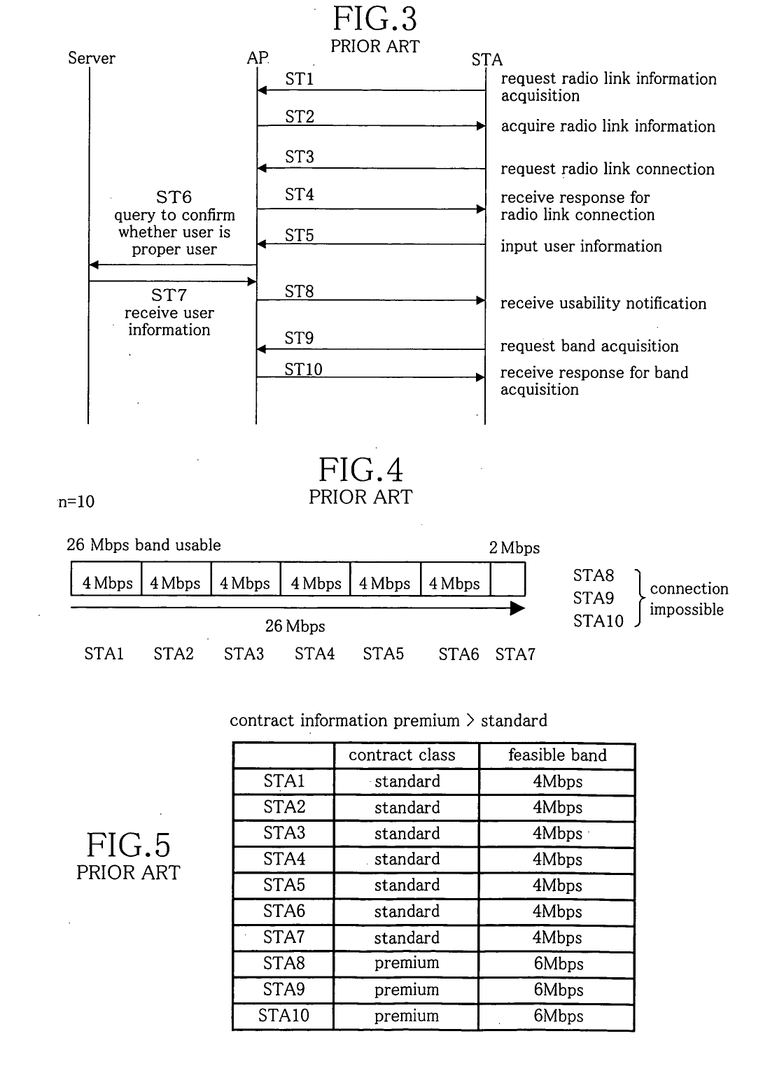

FIG. 7 shows a sequence for connecting a STA to an AP. First, likewise the steps described in the conventional example in FIG. 3, the steps from ST1 to ST9 are performed. Upon receipt of a request in ST9 from the STA, the AP allocates to the STA a band of a band that the AP manages. At this time, a band requested from a user is compared with a band set in user's contract information. When difference lies between these bands, the band requested from the user is changed.

Then, the STA receives a band acquisition response in ST10. In this way, the band that the STA is to use is secured and the STA can receive services such as data delivery.

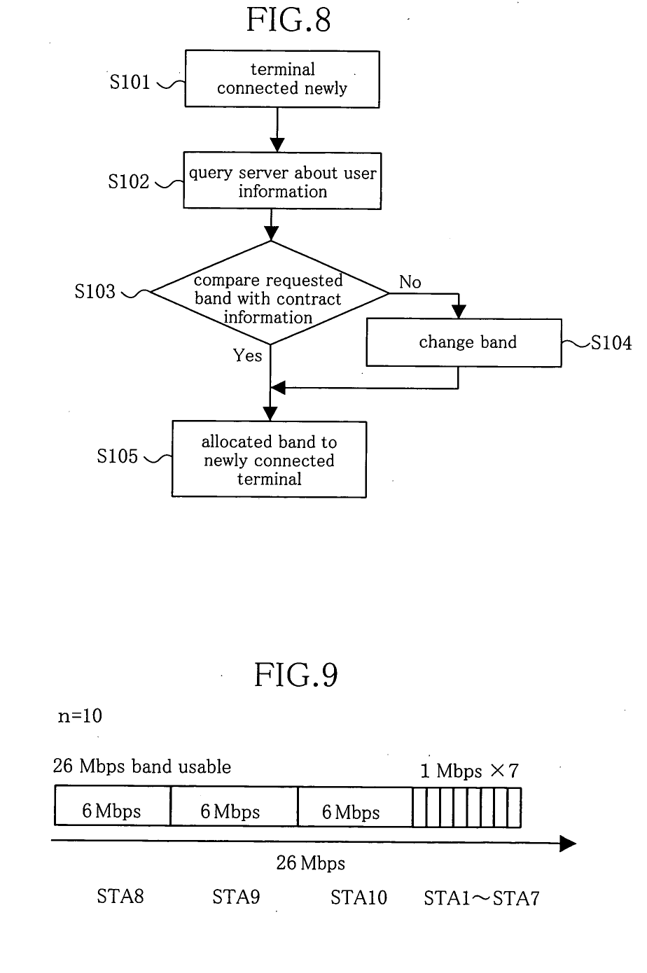

Next, a flow of the AP for contract information comparison and band allocation in response to a band request from a user is shown in FIG. 8. A STA is connected newly in a step S101, and the AP queries, in a step S102, a server about the contract information of the user using the STA that has sent the band request.

In a step S103, the requested band and the contract information are compared to check whether or not the user is requesting the band in accordance with his/her contract information.

When the comparison in the step S103 results in NO (the requested band is beyond the contract information), the routine branches to a step S104 to change the band to a band in accordance with the contract information in the step S104, followed by a step S105.

When the comparison in the step S103 results in YES (the requested band is within the contract information), the routine proceeds to the step S105 to perform band allocation to the newly connected STA in the step S105.

The above processing enables band allocation in accordance with the contract information as shown in FIG. 9.

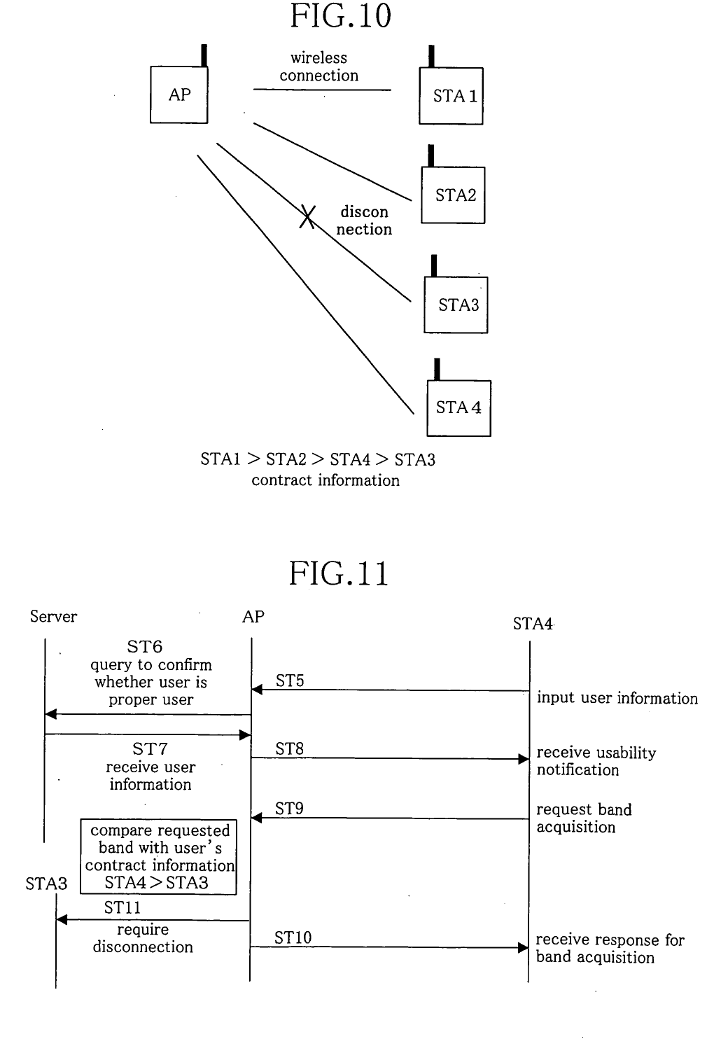

FIG. 10 shows a radio link state in the case where the STA 4 is newly connected to the AP under the circumstances that an insufficient range for band allocation remains. Suppose that the newly connected STA 4 is under a higher-class contract than the STA 3 that has been already connected. Accordingly, the STA 3 is disconnected for securing the band so that the STA 4 can use the band as contracted.

FIG. 11 shows steps for securing the band. When the STA 4 under the high-class contract than the STA 3 is connected newly, the STA 4 performs the steps from ST1 to ST9, likewise the steps described in the conventional example in FIG. 3. Then, when the STA 4 requests band acquisition in ST9, the contract information of the STA 1 through to STA 3, which have been already connected, is compared with that of the STA 4 under the circumstances that the AP has an insufficient range for a band to be allocated to the STA 4. In the present embodiment, the STA 3 is under the lower-class contract than the STA 4, and therefore, the AP sends a disconnection requirement to the STA 3 in ST11 to secure the band by disconnecting the radio link to the STA 3 while allocating a band to the STA 4 through the band acquisition response in ST10.

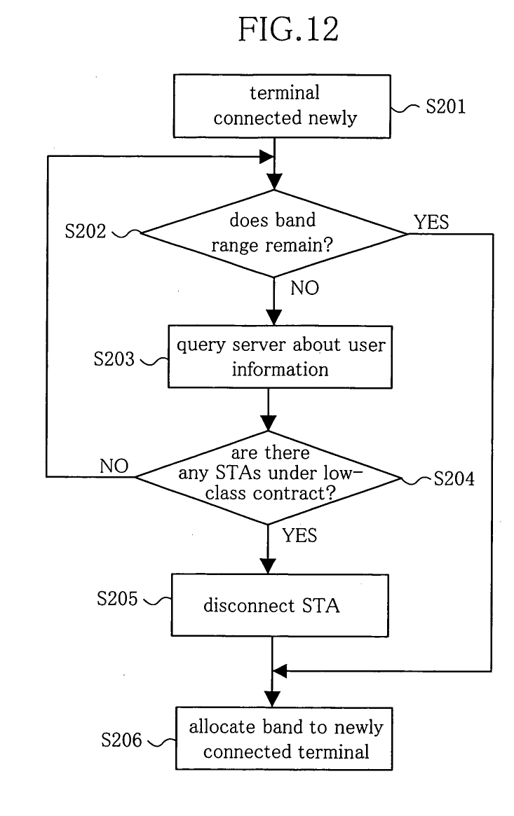

Next, a flow of processing of the AP for disconnecting a terminal under low-class contract for securing a band for a newly connected terminal is depicted in FIG. 12. A STA is connected newly in a step S201 first, followed by judgment in a step S202 as to whether or not a sufficient range in the band that the AP manages remains.

When the judgment in the step S202 results in “YES,” the routine branches to a step S206. On the other hand, when the judgment in the step S202 results in “NO,” the routine branches to a step S203.

In the step S203, the AP queries the server about the contract information of the user using the newly connected STA 4.

In a step S204, the contract information of the user using the newly connected STA 4 is compared with that of the users using the STAs that have been already connected to judge whether there are any STAs under a lower-class contract than that of the user of the newly connected STA among contracts of the users of the already connected STAs.

When the judgment in the step S204 results in “YES,” the routine proceeds to a step S205, and the AP sends a disconnection requirement to the STA 3 under the lower-class contract to disconnect the radio link thereof.

When the judgment in the step S20 results in “NO,” no band is allocated for the user using the new STA 4.

Then, the band secured by disconnecting the STA 3 under lower-class contract is allocated to the newly connected STA 4 in the step S206.

### Second Embodiment

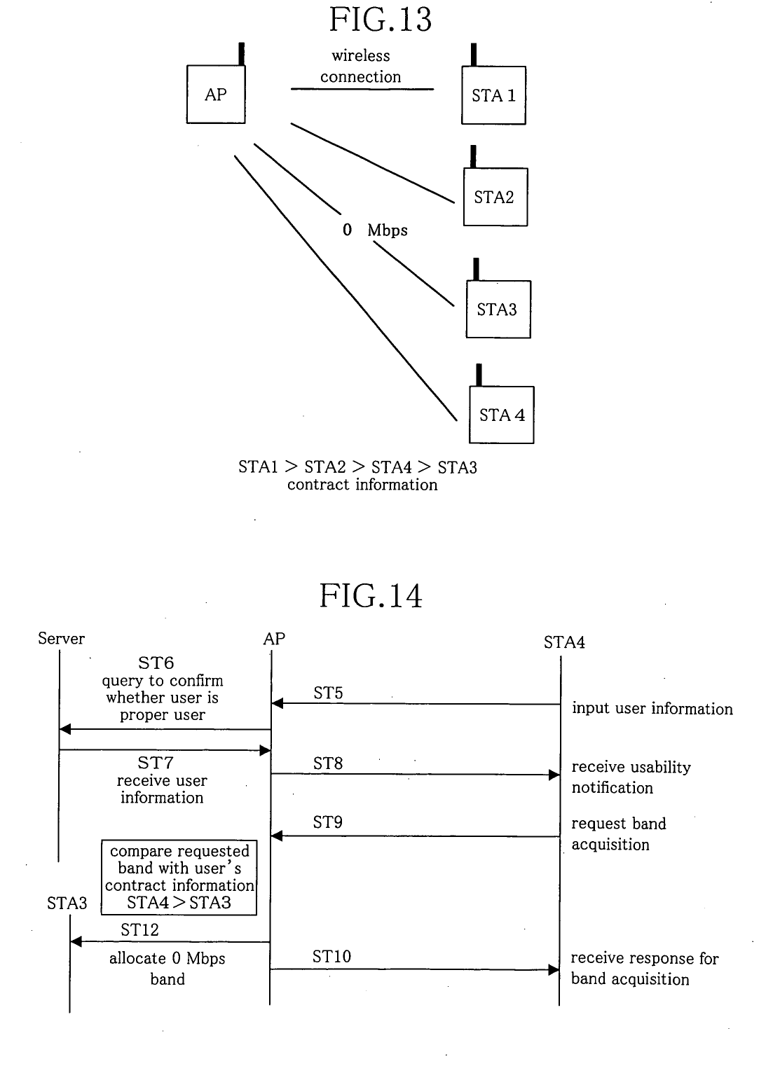

FIG. 13 shows the second embodiment of the present invention which embodies a radio link state where the STA 4 is connected newly under the circumstances that an insufficient range remains in the band. Herein, suppose that the newly added STA 4 is under a higher-class contract than the already connected STA 3. Accordingly, a band of 0 Mbps is allocated to the STA 3 so that the STA 4 can use the band as contracted, thereby securing the band.

FIG. 14 shows a sequence for securing the band. When the STA 4 under the higher-class contract than the STA 3 is connected, the STA 4 performs the steps from ST1 to ST9, likewise the steps described in the conventional example in FIG. 3. When the STA 4 requests band acquisition in ST9 under the circumstances that the AP has an insufficient range for a band to be allocated to the STA 4, the AP compares the contract information of the STA 4 with those of the STA 1 to STA 3. Because the STA 3 is under the lower-class contract than the STA 4 in the present embodiment, the AP allocates a band of 0 Mbps to the STA 3 in ST12 for securing the band by setting the usable band of the STA 3 to be 0 Mbps, and allocates a band to the STA 4 through a band acquisition response in ST10.

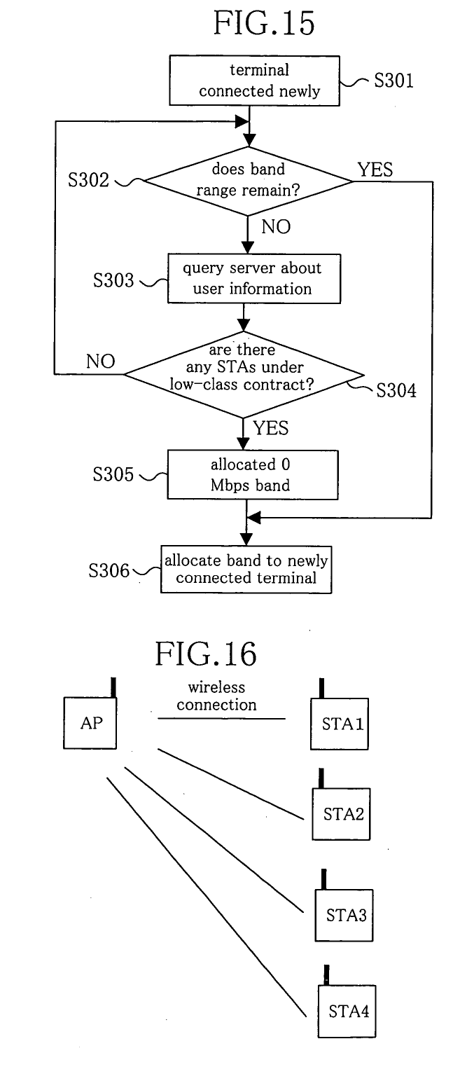

Next, a flow of processing of the AP for disconnecting, upon establishment of new connection of a terminal, a terminal under a low-class contract for securing the band is shown in FIG. 15. A STA is connected newly in a step S301, and whether or not a sufficient range remains in the band that the AP manages is judged in a step S302.

When the judgment in the step S302 results in “YES,” the routine branches to a step S306. When the judgment in the step S302 results in “NO,” the routine branches to a step S303.

In the step S303, the AP queries the server about the contract information of the user using the newly connected STA.

In a step S304, the contract information of the user using the newly connected STA is compared with that of the users using the already connected STAs to judge whether there are any STAs used by users who establishes a lower-class contract than the user of the newly connected STA.

When the judgment in the step S304 results in “YES,” the routine branches to a step S305 and the AP allocates a band of 0 Mbps to a STA used by a user who establishes the lower-class contract.

When the judgment in the step S304 results in “NO,” no band is allocated to the newly connected STA.

Then, in the step S306, the band secured by allocating the band of 0 Mbps to the STA under the lower-class contract is allocated to the newly connected STA.

### Third Embodiment

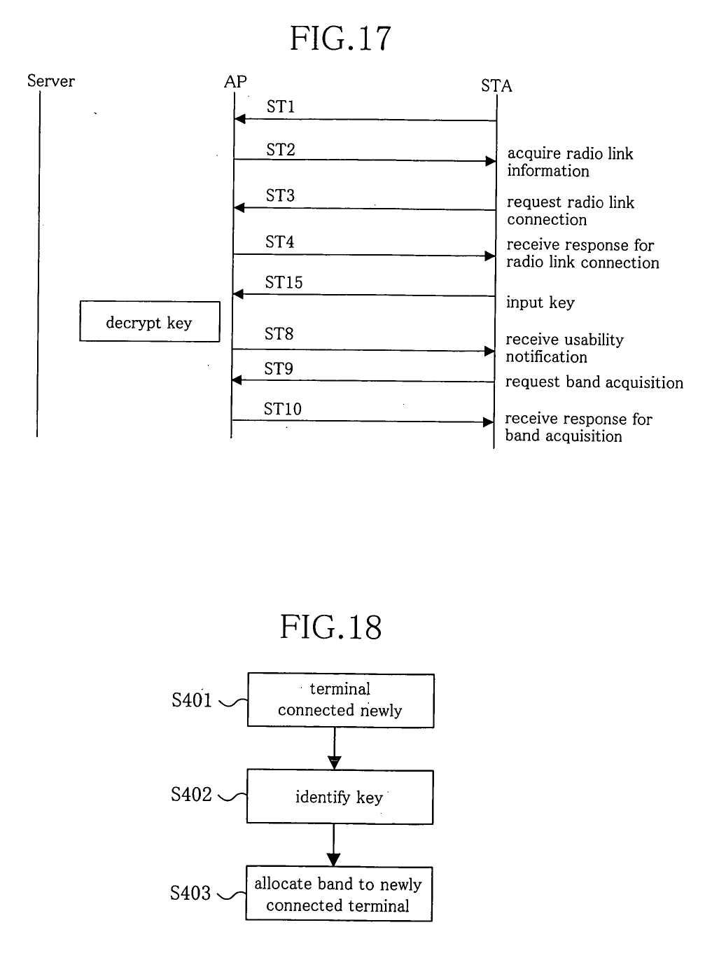

FIG. 16 shows a radio link state in the case of band allocation to STAs using a key in the third embodiment. FIG. 17 shows a sequence of band allocation using the key. First, a STA performs the steps from ST1 to ST4 for connection to the AP, likewise the steps described in the conventional example in FIG. 3. In the conventional example, user information is input for confirming the user information in ST5 and a usability notification is sent to the STA in ST8. In contrast, in the present embodiment, a key is input from the STA to the AP in ST15 and the AP decrypts to identify a key issued to the user who establishes a contract. This enables issuance of a usability notification in ST8 and of a band acquisition response in ST10 with need for confirmation of the user information eliminated, thereby improving the responsiveness.

FIG. 18 shows a flow of processing of the AP for user identification through key input. A STA is connected newly in a step S401, the AP identifies key information in a step S402, and then, the AP allocates a band to the newly connected STA based on the key information in a step S403.

The aforementioned processing enables the AP to perform band allocation with no need for query to the server about the contract information, thereby improving the responsiveness in band allocation.

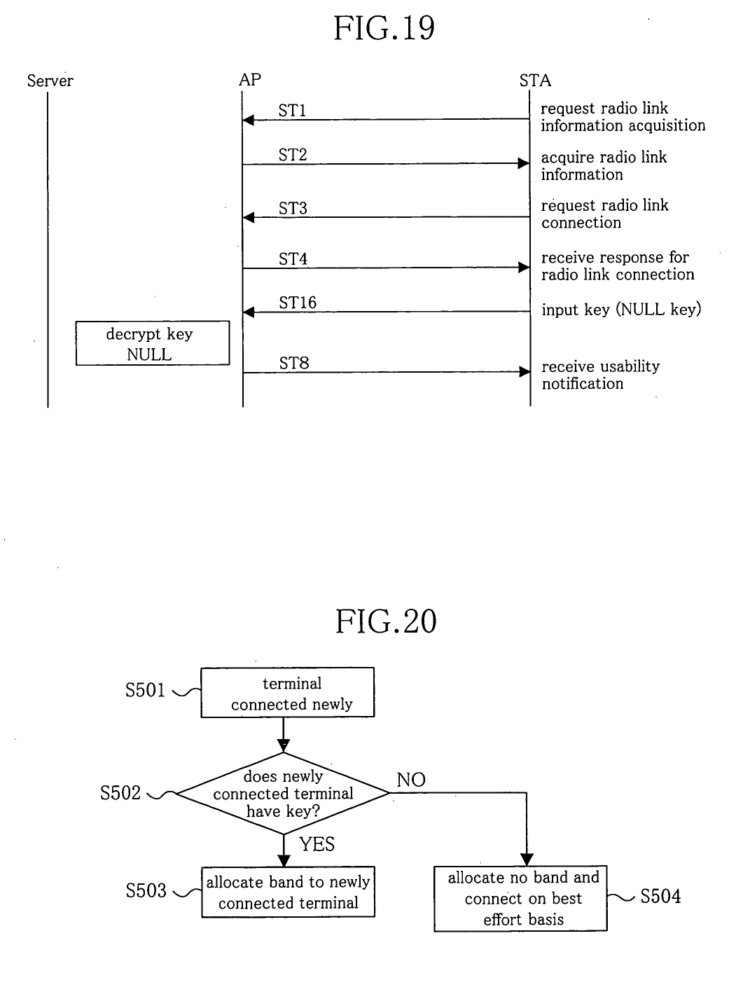

A sequence in the case where a user who is not assigned a key uses the wireless delivery service will be described next. FIG. 19 shows the sequence for band allocation with the use of a key. First, a STA performs the steps from ST1 to ST4 for connection to the AP, likewise the steps described with reference to FIG. 17. Then, a NULL key is input from the STA to the AP in ST16. When the key is identified as NULL by key decryption by the AP, only a usability notification in ST8 is sent to provide wireless connection on a best effort basis.

FIG. 20 shows a flow of processing of the AP for user identification through NULL key input. A STA is connected newly in a step S501, and the AP judges whether or not the newly connected STA has key information in a step S502.

When the judgment in the step S502 results in “YES,” the routine branches to a step S503 and a band is allocated to the newly connected STA based on the key information in the step S503.

When the judgment in the step S502 results in “NO,” the routine branches to a step S504 as it is judged based on the key information that the input key includes NULL. Then, connection on the best effort basis is provided to the newly connected STA in the step S504.

As described above, the wireless delivery service on the best effort basis is provided to a user trying connection even if he or she has no key under no contract. Hence, the services can be provided to users who establish no contract.

The present invention relates to systems and methods for providing adaptive service through wireless delivery, which enable band allocation in accordance with contract information. Therefore, the present invention is useful in wireless hot spot services and is applicable to services for digital contents delivery.

1. A system for providing adaptive service through wireless delivery comprising:
a sever that manages user information relating to users; and
a server terminal which is connected to the server and has a wireless communication function,
wherein when a user terminal having a wireless communication function is wireless connected to the server terminal, wireless delivery service is provided to a user using the user terminal, and
a band is allocated to the user terminal based on the user information that the server terminal obtains by querying the server.

2. A method for providing adaptive service through wireless delivery using a system for providing adaptive service through wireless delivery according to claim 1, comprising the steps of:
performing a procedure for changing a band of a user terminal only by the server and the server terminal; and
reallocating a band by the server terminal based on the user information according to an increase or a decrease in a number of wireless connected user terminals.

3. The method of claim 2, wherein
when a band to be allocated to a newly wireless connected user terminal cannot be ensured, a user terminal under a low-class contract based on the user information among already wireless connected user terminals is disconnected to secure the band to be allocated thereto.

4. The method of claim 2, wherein
when a band to be allocated to a newly wireless connected user terminal cannot be ensured, a band of 0 Mbps is allocated to a user terminal under a low-class contract based on the user information among already wireless connected user terminals to secure the band to be allocated thereto.

5. The method of claim 2, wherein
when a user requests a band beyond contract information that the user establishes, a band is allocated to user's user terminal based on the user information.

6. The method of claim 2, wherein
a band is allocated to the user terminal based on information on a key provided beforehand to the user.

7. The method of claim 6, wherein
wireless delivery service on a best effort basis is provided to a user having no key.
